(19) United States
(12) Patent Application Publication
(10) Pub. No.: US 2003/0178122 A1
(43) Pub. Date: Sep. 25, 2003

(54) High friction scrims, geonets, laminates and methods for using and making them

(76) Inventors: Peter J. Ianniello, Havre de Grace, MD (US); Giovanni Capra, Ellicott City, MD (US)

Correspondence Address: Gary L. Shaffer, Esq., 901 Banks Place, Alexandria, VA, 22312-5507, US

(21) Appl. No.: 10/366,691

(22) Filed: Feb. 14, 2003

Related U.S. Application Data
(60) Provisional application No. 60/356,139, filed on Feb. 14, 2002.

(51) Int. Cl. B32B 7/14

(52) U.S. Cl. 156/71; 156/324

(57) ABSTRACT

The present invention relates generally to scrims, geonets, void-maintaining geocomposite core elements and geocomposite structures comprising high-friction polymers, and methods for making and utilizing them. The high-friction characteristics of components of the invention provide increased resistance to the negative effects of shear forces in laminates which employ them. Scrims, geonets, void-maintaining geocomposite core elements and geocomposite structures according to the invention are particularly useful in slope installations where at least a portion of the geocomposite is at a slope angle of greater than 4 degrees.

### RELATED APPLICATIONS

The present application claims priority to U.S. Provisional Application No. 60/356,139, filed Feb. 14, 2002. U.S. Provisional Application 60/356,139 is hereby incorporated by reference.

### FIELD OF THE INVENTION

The present invention relates generally to scrims, geonets, void-maintaining geocomposite core elements and geocomposite structures comprising high-friction polymers and methods for making and utilizing them. The high-friction characteristics of components of the invention provide increased resistance to the negative effects of shear forces in laminates which employ them.

### BACKGROUND OF INVENTION

Water is the principal cause of distress in many types of structures. For this reason among others, geotechnical engineers and others skilled in the art specify or purchase sand, stone, clay and gravel as a means of providing drainage layers and structures to convey fluids away from the structure to, for example, collection pipes. For some years, conventional geonets and geocomposites (“geocomposites”) have been used to complement or replace natural earthen materials such as stone, gravel and clay. Typically, conventional geocomposites are manufactured with a rigid polymer geonet core element encased or laminated between permeable non-woven or woven fabrics commonly known in the art as geotextiles. These geonet-geotextile laminated structures are intended to retain the drainage or void spaces that exist in the geonet core element, in part, by retaining the relative positions of the layers with respect to one another over time.

The problems with conventional geocomposites, geonets, and methods for their use are numerous. For example, in many applications, such as in leachate collection systems, the laminates are exposed to extremely harsh chemical and mechanical stresses. These stresses often cause the failure of the bonds or adhesions between the void-maintaining core element and the geotextiles attached to the core. The failure of a significant number of adhesions or bonds between such layers often results in the shifting of the layers with respect to one another, intrusion of the outer layers into the void spaces, and the consequent failure of the geocomposite laminate to maintain a sufficient level of drainage performance. Such failures are particularly common in installations that undergo significant horizontal shear forces, that is, shear forces that occur approximately parallel to the plane of the geocomposite. Such forces are increased in installations of significant slope, such those sloping more than 3 degrees. There is thus a need in the field for geocomposites that are resistant to shear forces and particularly those installations having a slope more than 3 degrees.

Another problem in the field of geocomposites relates to stress cracking. For example, conventional polymer geonet cores, such as those made of polyethylene or polypropylene, commonly exhibit stress cracking when subjected to the mechanical and chemical stresses commonly found in sloped installations. Such polymer geonet cores and composites can fail or significantly diminish in performance capacity when they exhibit stress cracking or other mechanical failure. Of course, this is of great concern to those practitioners skilled in the design of landfill and large structure drainage systems. Typically, stress cracking impacts the performance of a geonet by making it more prone to unwanted reductions in thickness and porosity which, in turn, reduce the long-term flow performance of the system.

Furthermore, some engineers theorize that a stress-cracked geonet predisposes the attached geomembranes more prone to punctures or tears, and thus more susceptible to partial or complete failure under heavy loads. There is therefore a need for geocomposite components that exhibit superior resistance to stress failure due to stress cracking.

### SUMMARY OF THE INVENTION

It is therefore an object of the invention to provide scrims, geonets, void-maintaining geocomposite core elements and geocomposite structures comprising high-friction polymers.

It is another object of the invention to provide geocomposite laminates having superior characteristics with respect to functional longevity, performance and inter-layer resistance to shear forces.

It is a further object of the invention to provide methods for producing and utilizing such shear-resistant components and geocomposite laminates.

In accordance with these and other objects, the invention provides means and methods for providing high-friction geocomposite laminates having an increased resistance to horizontal shear forces. In one key embodiment, a method of the invention comprises the steps of

1) providing a sheet-like geocomposite core structure having a first surface and a second surface,

2) providing a first scrim of high-friction compound adjacent the first surface of the core, and

3) providing a first layer of geotextile or geomembrane adjacent the scrim. In other embodiments, methods of the invention may further comprise the step of adhering the scrim to the core structure, wherein the adhering is effected by one or more of thermal bonding, by means of one or more adhesives, by laser welding or by ultrasound.

Methods of the invention may further comprise the step of adhering the scrim to the first geotextile or geomembrane, for example by means of one or more of thermal bonding, one or more adhesives, laser welding and ultrasound. A further step may comprise bonding or adhering the first geotextile or geomembrane to both the scrim and to the core structure, wherein the adhering is effected, for example, by one or more of thermal bonding, one or more adhesives, laser welding and ultrasound.

In accordance with additional objects, methods of the invention may further comprise the step of placing the geocomposite laminate in a position within, under, adjacent or near a large structure, for example, one or more structures from the group including buildings, highways, parking lots, runways, roadways, stadiums and foundations. Methods of the invention are particularly useful in situations where all or at least a portion of the laminate is on a slope, for example, a slope away from the structure. Methods and laminates of the invention are particularly suitable for slopes in the range of from 1 degree to 25 degrees, preferably from 4 degrees to 20 degrees, more preferably from, 4 degrees to 15 degrees and most preferably from 4 degrees to 10 degrees.

Methods of the invention may include the further step of providing a second scrim of high-friction compound adjacent the second surface of the core, and providing a second layer of geotextile or geomembrane adjacent the second scrim. As an additional advantage, the second layer of geotextile or geomembrane may be adhered to one or both of the second scrim and the core structure. The adhering or bonding is preferably effected by one or more of thermal bonding, laser welding, one or more adhesives, and ultrasound. The present methods comprehend the use of first and second geotextiles and geomembranes that are textured, roughened or which include at least one fuzzy surface having bonding elements.

Scrims and geonets of the invention may comprise any substance having a coefficient of friction sufficiently high enough, so that when it is incorporated into an installation having a desired slope, the desired performance characteristics, longevity, and resistance to slope failure are achieved. Such high-friction substances include, as examples, one or more polymers from the group including ethylene vinyl acetates, styrene butadiene rubbers, polyesters, ABS, polybutylenes, recycled latexes, polyethylenes, rubberized polyethylenes, ethylene propylene diene monomers, ethylene vinyl alcohol copolymers, polypropylenes, rubberized polypropylenes, polybutadienes, plasticized polyvinyl chlorides, thermoplastic olefins and compounds derived from recycled tires.

The present methods and high-friction geocomposites include embodiments such as those where the scrim comprises one or more from the group consisting of nets, striated sheets, non-perforated sheets, and perforated sheets of high-friction material. Thus, the present means and methods advantageously provide for embodiments wherein the scrim comprises a net or perforated sheet and the adhering between the core structure and the first geomembrane or geotextile is effected through the interstices of the net or the perforations of the perforated sheet to thereby increase the number of attachment points between the several layers. By doing so, the present invention provides yet additional means whereby resistance to structural failure due to shear forces is further bolstered. This structural strategy is embodied further with respect to the second scrim and geomembrane or geotextile. Thus, the second scrim may comprise a net or perforated sheet and the adhering between the core structure and the second geomembrane or geotextile can be effected through the interstices of the net or through the perforations of the perforated sheet.

The invention provides also for decreasing the destructive effects of, or increasing effective resistance to, horizontal shear forces that arise between layers in geocomposite laminates in situ. This method embodiment of the invention comprises the steps of A) providing a sheet-like geocomposite core structure having a first surface and a second surface, B) providing a first layer of geotextile or geomembrane disposed adjacent or nearly adjacent the core structure, and C) providing means for increasing the coefficient of friction between the first surface of the core structure and the first layer.

Means for increasing the coefficient of friction between the first surface of the core structure and the first layer include, as examples, providing a high-friction scrim between the first surface of the core structure and the first layer, providing the geotextile or geomembrane in the form of a fuzzy textile or fuzzy membrane, providing the geotextile or geomembrane with at least one high-friction textured surface, providing the core structure in a form wherein it comprises at least one high-friction polymer or elastomer, and providing the core structure in a form wherein it consists of at least one high-friction polymer or elastomer, or both.

In accordance with yet additional objects, methods of the invention may include the further step of adhering the core structure to one or both of the first layer of geotextile or geomembrane and the high-friction scrim. The adhesion or bonding of the geotextile or geomembrane to one or both of the scrim and the core structure can be effected by any means or methods that result in sufficient resistance to movement under shear forces, including one or more of thermal bonding, such as flame welding or co-extrusion, the simultaneous or serial application of one or more adhesives or solvents, laser welding and ultrasound. As one of skill in the art will appreciate, such additional bonding means increases further the degree of adhesion between and among the two or more layers of the present geocomposites.

These advantages are found also in other aspects of the present methods where further steps include providing a second scrim of high-friction compound adjacent the second surface of the core, and providing a second layer of geotextile or geomembrane adjacent the second scrim. As with other embodiments, the adhering or bonding of the second layer of geotextile or geomembrane to one or both of the second scrim and the core structure can be effected by any means or methods that result in sufficient resistance to movement under shear forces. Such means or methods include one or more of thermal bonding, the simultaneous or serial application of one or more adhesives or solvents, laser welding and ultrasound.

As one of skill in the polymer arts will comprehend, there are numerous polymers that have, or that can be treated or processed to have high-friction characteristics that are suitable for use in making scrims, high-friction core structure geonets, or both, as disclosed herein. These polymers include, for example, ethylene vinyl acetates, styrene butadiene rubbers, polyesters, ABS, polybutylenes, recycled latexes, polyethylenes, rubberized polyethylenes, ethylene propylene diene monomers, ethylene vinyl alcohol copolymers, polypropylenes, rubberized polypropylenes, polybutadienes, plasticized polyvinyl chlorides, thermoplastic olefins as well as a myriad of compounds derived from recycled tires.

The invention also comprehends embodiments where impermeable or low-permeability membranes are combined with void-maintaining cores. In embodiments comprising one or more low-permeability membranes, the geomembrane preferably has a permeability of less than 1×10⁻⁵ cm sec⁻¹. In numerous permutations and embodiments, the high-friction geocomposite laminates and methods of the invention are particularly useful in situations where all or at least a portion of the laminate is on a slope, for example, a slope away from the structure. Numerous variations and permutation of methods and laminates of the invention are particularly suitable for slopes in the range of from 1 degree to 25 degrees, preferably from 4 degrees to 20 degrees, more preferably from 4 degrees to 15 degrees and most preferably from 4 degrees to 10 degrees.

### DETAILED DESCRIPTION OF THE INVENTION

The present invention utilizes high-friction scrims, geonets and compounds to provide geotextiles, fabrics, membranes and combinations thereof that yield the advantageous characteristics of high resistance to horizontal shear forces. The present invention relates generally to means and methods for making and utilizing them. The high-friction characteristics of components of the invention provide increased resistance to the negative effects of shear forces in laminates which employ them. Geocomposites of the present invention exhibit superior strength with respect to resisting the destructive effects of shear forces on the void-maintaining capacities, particularly in sloped installations. Because of this, geonets and geocomposites of the present invention can be used, for example, to more effectively replace or complement sand, stone, or gravel underneath pavement structures, or used in landfills or in other types of geotechnical applications.

By providing a synthetic drainage system or impermeable barrier that includes the heretofore unknown high-friction components, the present invention overcomes the disadvantages of laminar separation and geocomposite failure caused by adhesive failure under the stresses caused by horizontal shear forces. The textiles and fabrics used in laminates of the present invention are preferably manufactured with specified or defined permeability and permittivity properties in order to adapt or integrate them into drainage systems that have effective useful lives. A high-permittivity core element, such as the geonet shown in U.S. Pat. 5,891,549 to Beretta et al., is exemplary of geonets suitable for use with high-friction scrims of the present invention. Numerous other geonets and void-maintaining layers are also suitable for use in the invention.

Scrims and geonets of the invention may comprise any substance having a coefficient of friction sufficiently high enough, so that when it is incorporated into an installation having a desired slope, the desired performance characteristics, longevity, and resistance to slope failure are achieved. Such high-friction substances include, as examples, one or more polymers from the group including ethylene vinyl acetates, styrene butadiene rubbers, polyesters, ABS, polybutylenes, recycled latexes, polyethylenes, rubberized polyethylenes, ethylene propylene diene monomers, ethylene vinyl alcohol copolymers, polypropylenes, rubberized polypropylenes, polybutadienes, plasticized polyvinyl chlorides, thermoplastic olefins and compounds derived from recycled tires.

Tire rubber compounds useful for practicing the present invention are those that are known in the art of tire manufacturing and tire recycling. Used tires that have been processed into usable elastomers, for example, by the methods disclosed in U.S. Pat. Nos. 5,114,648; 6,129,877 and 5,494,510, all to Kuc, Sr., are adaptable for use in the present invention. These patents are hereby incorporated by reference. Geonet cores and scrims produced in whole or in part from the polymers and rubber used to make tires have superior performance to conventional products in the field. Pelletized tire chips marketed under the trademark Duroplas® are one source of re-formulated tire rubber and tire polymer compounds suitable for co-extrusion with other polymers according to the present invention. Other sources of such reformulated tire materials are also suitable for practicing the invention.

The present invention provides high-friction elements, such as geonets, scrims, geomembranes and geotextiles that can be combined with one another or with conventional geo-structures such as geonets, geomembranes and geotextiles, or combinations of these, such as are typically found in geo-laminates. Such high-friction elements increase the layer-to-layer adhesion and resistance to horizontal shear between adjacent layers in a geocomposite laminate. Because of this, geo-structures incorporating the present invention, such as void-maintaining drainage laminates, can be installed and used at greater slope angles while increasing the resistance to failure caused by shear forces thus decreasing slope failure and the need for anchors in sloped installations.

The present invention includes high-friction geonets formed by co-extruding conventional geonet polymers, such as polyethylene, with pelletized tire chips. As one of skill in the extrusion of geonets will comprehend, there are numerous permutations of combinations of conventional plastics, such as polyethylene, with recycled tire chips or their derivatives formed into pellets, that will impart desired characteristics to a tire compound based high-friction geonet according to the invention. The numerous permutations of the present invention can be evaluated by using ASTM Standard 5321 which relates to friction angles of geosynthetic installations, and ASTM Standard 4716, which pertains to flow characteristics under load. ASTM Standard 5321 and ASTM Standard 4716, and their means and methods, are hereby incorporated by reference.

The expected characteristics of a typical high-friction geonet according to the invention include a performance of 5×10⁻⁴ cm M² sec⁻¹ under a normal load greater than 100 PSF when tested under ASTM Standard 4716 and used in conjunction with an impermeable membrane on at least one surface of the geonet, such as an HDPE textured membrane, or textured PVC, or in conjuncyion with a compacted clay liner or a membrane having a permeability of less than 1×10⁻⁵ M² sec⁻¹.

Typical Characteristics of a High-Friction Tire-Compound Geonet According to the Invention:

A geonet or scrim comprising at least one high-friction compound derived from tire rubber compounds according to the invention, when combined within a geocomposite having at least one layer of a membrane, non-woven or woven fabric, wherein that layer is thermally, adhesively, or ultrasonically bonded to a polymeric core element typically results in a finished product that:

1) Obtains tensile strength of at least 25 lbs./ft in both machine and cross machine direction when tested in accordance with ASTM D 4595.

2) Maintains external dimensions of not less than 0.01 nor more than 4.0 inches while being able to transmit fluid at a rate of 1×10⁻⁵ M²/sec to 9×10⁻² M²/sec when tested utilizing ASTM D 4716 under sustained load of not less than 721 kPa (10 psf) for a duration of not less than 100-hours at gradients that range from 0.02, 0.5 and 1.0 when the boundary conditions to which the product is exposed include steel plates as well as in a soil environment.

3) Resists structural catastrophic collapse under load by retaining greater than 10% of its dimensional thickness under sustained normal load of at least 500 psf.

4) May have geotextiles laminated to the geonet or in intimate contact with geonet.

5) May be placed directly on top of a geomembrane.

Although the present invention has been described in connection with specific forms and permutations, those skilled in the art will appreciate that various modifications and other than those discussed herein are within the scope and spirit of the invention. For example, equivalent elements may be substituted for those specified herein, certain features may be used independently of other features, and process steps may be modified, reversed or interposed, all without departing from the invention as recited in the following claims.

What is claimed is:

1. A method for providing geocomposite laminates having an increased resistance to horizontal shear forces, comprising the steps of
A. providing a sheet-like geocomposite core structure having a first surface and a second surface,
B. providing a first scrim of high-friction compound adjacent said first surface of said core, and
C. providing a first layer of geotextile or geomembrane adjacent said scrim.

2. The method of claim 1, further comprising the step of
D. adhering said scrim to said core structure,
wherein said adhering is effected by one or more of thermal bonding, one or more adhesives, laser welding and ultrasound.

3. The method of claim 1, further comprising the step of
E. adhering said scrim to said first geotextile or geomembrane,
wherein said adhering is effected by one or more of thermal bonding, one or more adhesives, laser welding and ultrasound.

4. The method of claim 1, further comprising the step of
F. adhering said first geotextile or geomembrane to both said scrim and to said core structure,
wherein said adhering is effected by one or more of one or more adhesives, thermal bonding, laser welding and ultrasound.

5. The method of claim 1, further comprising the step of
G. placing said geocomposite laminate in a position within, under, adjacent or near a large structure,
wherein said large structure is one or more from the group consisting of buildings, highways, parking lots, runways, roadways, stadiums and foundations.

6. The method of claim 5, wherein said position includes at least a portion of said laminate on a slope away from said structure.

7. The method of claim 6, wherein said slope away from said structure is between 1 degree and 25 degrees.

8. The method of claim 7, wherein said slope away from said structure is from 1 degree to 25 degrees.

9. The method of claim 7, wherein said slope away from said structure is from 4 degrees to 20 degrees.

10. The method of claim 7, wherein said slope away from said structure is from 4 degrees to 10 degrees.

11. The method of claim 7, wherein said slope away from said structure is from 4 degrees to 15 degrees.

12. The method of claim 1, further comprising the step of
H. providing a second scrim of high-friction compound adjacent said second surface of said core, and
I. providing a second layer of geotextile or geomembrane adjacent said second scrim.

13. The method of claim 12, further comprising the step of
J. adhering said second layer of geotextile or geomembrane to one or both of said second scrim and said core structure,
wherein said adhering is effected by one or more of one or more adhesives, thermal bonding, laser welding and ultrasound.

14. The method of claim 1, wherein said first geotextile or geomembrane is textured, roughened or comprises at least one fuzzy surface having bonding elements.

15. The method of claim 12, wherein said second geotextile or geomembrane is textured, roughened or comprises at least one fuzzy surface having bonding elements.

16. The method of claim 1, wherein said scrim comprises one or more polymers from the group consisting of ethylene vinyl acetates, styrene butadiene rubbers, polyesters, ABS, polybutylenes, recycled latexes, polyethylenes, rubberized polyethylenes, ethylene propylene diene monomers, ethylene vinyl alcohol copolymers, polypropylenes, rubberized polypropylenes, polybutadienes, plasticized polyvinyl chlorides, thermoplastic olefins and compounds derived from recycled tires.

17. The method of claim 1, wherein said scrim comprises one or more from the group consisting of nets, non-perforated sheets, and perforated shees of high-friction material.

18. The method of claim 4, wherein said scrim comprises a net or perforated sheet and said adhering between said core structure and said first geomembrane or geotextile is effected through the interstices of said net or the perforations of said perforated sheet.

19. The method of claim 12, wherein said second scrim comprises a net or perforated sheet and said adhering between said core structure and said second geomembrane or geotextile is effected through the interstices of said net or the perforations of said perforated sheet.

20. A method for decreasing the destructive effects of [increasing resistance to?] horizontal shear forces between layers in geocomposite laminates, comprising the steps of
A. providing a sheet-like geocomposite core structure having a first surface and a second surface,
B. providing a first layer of geotextile or geomembrane disposed adjacent or nearly adjacent said core structure, and
C. providing means for increasing the coefficient of friction between said first surface of said core structure and said first layer.

21. The method of claim 20, wherein said means for increasing the coefficient of friction between said first surface of said core structure and said first layer is at least one selected from the group consisting of
a) providing a high-friction scrim between said first surface of said core structure and said first layer,
b) providing said geotextile or geomembrane in the form of a fuzzy textile or fuzzy membrane,
c) providing said geotextile or geomembrane with at least one high-friction textured surface,
d) providing said core structure in a form wherein it comprises at least one high-friction polymer or elastomer, and
e) providing said core structure in a form wherein it consists of at least one high-friction polymer, elastomer or both.

22. The method of claim 21, further comprising the step of
D. adhering said core structure to one or both of
i) said first layer of geotextile or geomembrane and
ii) said high-friction scrim,
wherein said adhering is effected by one or more of thermal bonding, one or more adhesives, laser welding and ultrasound.

23. The method of claim 21, further comprising the step of
E. providing a second scrim of high-friction compound adjacent said second surface of said core, and
F. providing a second layer of geotextile or geomembrane adjacent said second scrim.

24. The method of claim 23, further comprising the step of
G. adhering said second layer of geotextile or geomembrane to one or both of said second scrim and said core structure,
wherein said adhering is effected by one or more of thermal bonding, one or more adhesives, laser welding and ultrasound.

25. The method of claim 21, wherein said high-friction scrim comprises one or more polymers from the group consisting of ethylene vinyl acetates, styrene butadiene rubbers, polyesters, ABS, polybutylenes, recycled latexes, polyethylenes, rubberized polyethylenes, ethylene propylene diene monomers, ethylene vinyl alcohol copolymers, polypropylenes, rubberized polypropylenes, polybutadienes, plasticized polyvinyl chlorides, thermoplastic olefins and compounds derived from recycled tires.

26. The method of claim 21, wherein said high-friction core structure comprises at least one high-friction polymer or elastomer selected from the group consisting of of ethylene vinyl acetates, styrene butadiene rubbers, polyesters, ABS, polybutylenes, recycled latexes, polyethylenes, rubberized polyethylenes, ethylene propylene diene monomers, ethylene vinyl alcohol copolymers, polypropylenes, rubberized polypropylenes, polybutadienes, plasticized polyvinyl chlorides, thermoplastic olefins and compounds derived from recycled tires.

27. The method of claim 20, wherein said geomembrane has a permeability of less than 1×10⁻⁵ cm sec⁻¹.

28. The method of claim 21, further comprising the step of
H. placing said geocomposite laminate in a position within, under, adjacent or near a large structure,
wherein said large structure is one or more from the group consisting of buildings, highways, parking lots, runways, roadways, stadiums and foundations.

29. The method of claim 28, wherein said position includes at least a portion of said laminate on a slope away from said structure.

30. The method of claim 29, wherein said slope away from said structure is between 1 degree and 25 degrees.
